(19) United States
(12) Patent Application Publication
(10) Pub. No.: US 2022/0185708 A1
(43) Pub. Date: Jun. 16, 2022

(54) A PROCESS AND APPARATUS FOR ACID MINE DRAINAGE TREATMENT

(71) Applicant: Engineroom Infrastructure Consulting Pty Ltd, Wootha (AU)

(72) Inventor: Emma Thompson-Brewster, Wootha (AU)

(21) Appl. No.: 17/442,581

(22) PCT Filed: Mar. 25, 2020
(86) PCT No.: PCT/AU2020/050282

§ 371 Date: Sep. 23, 2021

(30) Foreign Application Priority Data
Mar. 25, 2019 (AU) 2019900984

(51) Int. Cl. C02F 1/467; B01D 61/42; C02F 1/469; C02F 1/461

(52) U.S. Cl. CPC C02F 1/4678; B01D 61/427; C02F 2103/10; C02F 1/46104; C02F 2209/06; C02F 1/4698

(57) ABSTRACT

An apparatus for the treatment of acid mine drainage and selective recovery of at least one of metals, critical elements, sulphuric acid and water is disclosed. The apparatus includes at least one electrochemical reactor, at least one catholyte reservoir and at least one anolyte reservoir for containing the acid mine drainage and a buffer, respectively. The reservoirs are in fluid communication with the at least one electrochemical reactor. The apparatus also includes at least one sensor for monitoring a pH of a contents of the reactor; and a power source for supplying an electrical current to the at least one electrochemical reactor. The electrical current is supplied until a predetermined pH is reached for the selective recovery of the at least one of metals, critical elements, sulphuric acid and water. A process for the treatment of acid mine drainage is also disclosed.

### TECHNICAL FIELD

The present invention relates to an apparatus and a process for treatment of acid mine drainage and selective recovery of at least one of metals, critical elements, sulphuric acid and water.

### BACKGROUND

Acid mine drainage (or acid rock drainage) (AMD), is a major global environmental phenomenon. AMD usually forms when rock is exposed to oxygen, water, and/or microorganisms resulting in oxidation processes that mobilise sulphates and other elements present in the rock (and particularly in rocks containing pyrite). There are limited economically viable options for preventing and/or treating AMD.

AMD is typically acidic and may contain high concentrations of sulphates, iron and other transition and heavy metals, and metalloids of potentially toxic significance. The outflow can severely contaminate nearby groundwater and surface water having a detrimental impact on the environment.

AMD is known to occur wherever a ground substrate is disturbed, such as, e.g., during or following mining or construction activities.

Typically, AMD is treated using a basic principle of neutralization or oxidation/aeration. For example, neutralisation or oxidation/aeration may be achieved by adding alkaline chemicals (NaOH, lime, limestone, fly ash etc.), chemical oxidants (e.g. H₂O₂) or microorganisms.

However, a problem in general with such treatments is that they are often ineffective due to the chemistry of the AMD and the scale of the problem area. Further, most known treatment options produce a sludge of variable volume, composition and characteristics depending on the AMD source and the treatment method used. This sludge presents further problems in that it requires dewatering and storage, which when combined with treatment and transport costs, contributes significantly to water treatment and legacy costs of a mine. If exposed, the sludge can convert back into AMD.

Further, current treatments do not remove any metals or other elements of value from AMD, such as critical elements. Critical elements have been highlighted by organisations, such as, the European Commission, as metals of particular economic and societal interest, of which the total abundance or the global disparity is cause for concern. For example, the global supply of heavy rare earth elements is dominated by Chinese production, and the search for diverse sources is increasing.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention are directed to an electrochemical process and apparatus, which may at least partially overcome at least one of the abovementioned disadvantages or provide the consumer with a useful or commercial choice.

The present invention is predicated in part on the basis that electrochemical pH neutralization of AMD is an alternative to chemical neutralization that does not require chemical additives.

Accordingly, rather than adding chemical hydroxides or carbonates to AMD to increase pH, a cathodic reduction reaction may drive metal hydroxide, oxide or sulphate precipitation. The concentration of hydroxide ions in a subject solution increases through the electrode reaction concomitantly with migration of sulphate anions from the AMD through an anion exchange membrane (AEM) from a catholyte bath or chamber into a separate anolyte bath or chamber.

The present invention is also predicated in part on the determination that the recovery of critical elements from AMD could offset treatment costs and provide a change in the economic balance necessary for AMD treatment to be conducted on a scale required.

The present invention is lastly predicated on the determination that different metal oxides, hydroxides and sulphates become saturated at different pHs.

According to a first aspect of the present invention, there is provided an apparatus for treatment of acid mine drainage and selective recovery of at least one of metals, critical elements, sulphuric acid and water, said apparatus including:

at least one electrochemical reactor;

at least one catholyte reservoir and at least one anolyte reservoir for containing the acid mine drainage and a buffer, respectively, said reservoirs being in fluid communication with the at least one electrochemical reactor;

at least one sensor for monitoring a pH of a contents of the reactor; and

a power source for supplying an electrical current to the at least one electrochemical reactor,

wherein the electrical current is supplied until a predetermined pH is reached for the selective recovery of the at least one of metals, critical elements, sulphuric acid and water.

According to a second aspect of the present invention, there is provided, an apparatus for treatment of acid mine drainage and selective recovery of at least one of metals, critical elements, sulphuric acid and water, said apparatus including:

a first electrochemical reactor in fluid communication with a first catholyte reservoir and at least a second electrochemical reactor in fluid communication with a second catholyte reservoir, wherein the first and second catholyte reservoirs are in fluid communication with each other and are for containing the acid mine drainage;

at least one anolyte reservoir for containing a buffer, the anolyte reservoir being in fluid communication with the first electrochemical reactor;

at least a first sensor for monitoring a pH of contents of the first electrochemical reactor;

at least a second sensor for monitoring a pH of contents of the second electrochemical reactor; and

a power source for supplying an electrical current to the first and second electrochemical reactors,

wherein the electrical current is supplied until a predetermined pH is reached for the selective recovery of the at least one of metals, critical elements, sulphuric acid and water.

Advantageously, the apparatus may allow selective recovery of at least one of metals, critical elements, sulphuric acid and water. In particular, the apparatus allows separation of precipitated metals and/or critical elements without the need for thickening or filtering processes.

Further, the apparatus may advantageously allow treatment of AMD without the addition of chemicals, in particular alkaline chemicals, chemical oxidants or microorganisms, to the AMD.

Yet further, the precipitation process results in smaller volumes of solids with higher percentages of valuable elements, settles quickly, and produces cleaner treated water from the AMD than existing processes.

Further, precipitation is encouraged to occur within the catholyte reservoir, thus resisting the occurrence of precipitation and/or adherence of precipitant on the cathode electrode surface. This is advantageous as precipitation on the cathode surface may limit the efficiency of the process and, in some instances, clog the reactor.

Yet further, the apparatus according to the second aspect may advantageously allow for the selective recovery of metals and critical elements.

AMD is the outflow of acidic water which typically forms when rock, especially rock containing pyrite, is exposed to oxygen, water and/or microorganisms resulting in oxidation processes that dissolve the iron, sulphate and other elements present in the rock.

AMD may typically have a pH of about 2.5 to about 6.0, however, depending on the source, AMD may have a pH falling outside this range.

Electrochemical reactors generally have two conductive electrodes, called the anode and the cathode, which may be separated by a semipermeable membrane. The semipermeable membrane divides the reactor into an anode chamber containing the anode and a cathode chamber containing the cathode. An electric current is applied to the reactor causing electrons to be drawn from the anode and passed to the cathode using an external power source.

Typically, in such reactors, the anode chamber contains an electrolyte known as the anolyte and the cathode chamber contains an electrolyte known as the catholyte. The ions within the electrolytes may move in between the anode and cathode chamber depending on the type of membrane used. For example, when an anion exchange membrane (AEM) is used only anions within the electrolytes may pass through the membrane between the chambers.

The present invention uses electrochemical reactors to drive the reactions required to treat AMD as well as to drive the recovery of at least one of metals, critical elements, sulphuric acid and/or water.

In the present invention, AMD is used as the catholyte which is subjected to reduction reactions within the cathode chamber. The reduction reactions drive metal hydroxides, oxides or sulphates to precipitate out of the AMD solution. The pH of the catholyte increases due to the concentration of hydroxide ions in the AMD increasing through the reduction reactions concomitantly with the migration of sulphate anions from the AMD catholyte through an AEM into a separate anolyte solution or buffer contained within the anode chamber.

The process not only treats the AMD to recover treated water, but also advantageously allows recovery of the precipitated metals and/or critical elements and the recovery of sulphuric acid formed within the anolyte.

The buffer may comprise any solution suitable for resisting a change in pH upon the addition of an acidic or basic component or components, preferably the former.

In some embodiments, the buffer may be a sodium borate buffer solution. Typically, the buffer may be 1 M sodium borate buffer solution.

In other embodiments, the buffer may be water.

In yet other embodiments, the buffer may be an acidic buffer. In such embodiments, the buffering agent may be citric acid, acetic acid or sulphuric acid.

The metals recovered may generally depend on the source and composition of the AMD. Thus, the metals recovered may include any selected metal present within the AMD. For example, the metals or critical elements recovered may be at least one of iron, aluminium, magnesium, hafnium, rhenium, tantalum, uranium, germanium, indium, gallium, beryllium, zirconium, tungsten, aluminium, PGMs, barite, fluorspar, arsenic, scandium, strontium, titanium, potash, chromium, tin, tellurium, manganese, vanadium, niobium, lithium, cobalt, antimony, graphite, rubidium, caesium, bismuth or metal hydroxides, oxides, (oxy)hydroxides or sulphates thereof. In particular, the at least one of metals or critical elements recovered may be aluminium, arsenic, barium, chromium, copper, iron, molybdenum, selenium, lead, cobalt, magnesium, manganese, molybdenum, nickel, zinc or cadmium.

The critical elements recovered may include rare earth elements and yttrium (collectively known as REY). For example, the critical elements may be any one of cerium, dysprosium, erbium, europium, gadolinium, holmium, lanthanum, lutetium, neodymium, praseodymium, promethium, samarium, scandium, terbium, thulium, ytterbium, and yttrium or a hydroxide, oxides, (oxy)hydroxides, or sulphate thereof. In particular, the REY recovered may be any one of yttrium, neodymium, cerium, gadolinium, dysprosium and samarium. The REY may also include any one of erbium, europium, holmium, lutetium, praseodymium, terbium, thulium and ytterbium, typically in lower concentrations.

A skilled person would appreciate that REY represents a subset of critical elements.

In some embodiments, the critical element recovered may be yttrium.

In some embodiments, the rare earth elements recovered may include any one of rhenium, rubidium, scandium, strontium, tantalum, tellurium, tin, titanium, tungsten, uranium, vanadium, and zirconium.

In some embodiments, the sulphuric acid may be recovered from the AMD through migration of sulphate anions through the membrane into the anode chamber where they form sulphuric acid.

In some embodiments, the sulphuric acid may be recovered from the buffer within the anode chamber of the reactor.

In some embodiments, the recovered water may be recovered from the acid mine drainage in the cathode chamber of the reactor.

In some embodiments, the recovered water may have a final water quality that meets regulatory guidelines for downstream uses, for example, Australian and New Zealand Environment and Conservation Council (ANZECC) guidelines.

In some embodiments, the anode chamber of the first reactor is in fluid communication with the anode chamber of the second reactor.

In other embodiments, the anolyte reservoir may be in fluid communication with the anode chamber of the first reactor.

Fluid communication between different components of the system may include the use of, for example, one or more tubes, hoses, pipes or openings such that the AMD and/or buffer are capable of flowing and/or moving between different components of the apparatus. Typically, fluid communication is achieved through the use of tubing. For example, in some embodiments tubing may be used to allow buffer to flow from the anode chamber of the first reactor to the anode chamber of the second reactor.

In some embodiments, the predetermined pH for contents of the first reactor may be different to the predetermined pH for contents of the second reactor. Advantageously, the apparatus in this embodiment may allow the selective recovery of at least two metals, critical elements, sulphuric acid and/or water.

Each electrochemical reactor may be of any suitable size, shape and construction and may be formed from any suitable material or materials known in the art. For example, the electrochemical reactor may have a volume of about 1 L, about 2 L, about 3 L, about 4 L, about 5 L, about 10 L, about 15 L, about 20 L, about 25 L, about 50 L, about 100 L, about 200 L, about 300 L, about 400 L, about 500 L, about 600 L, about 700 L, about 800 L, about 900 L or about 1000 L or more. A person skilled in the art will appreciate that the limiting factor in the design of the electrochemical reactor is the size of the electrochemical cell, which can be around 50 centimetres diameter before its efficiency starts to reduce and zones of unmixed solution start to occur. Accordingly, larger volumes may be processed by having a number of electrochemical reactors in parallel.

Typically, the electrochemical reactor may comprise at least one anode electrode and at least one cathode electrode separated by a membrane to form an anode chamber and a cathode chamber.

The anode electrode may be of any suitable size, shape and construction capable of conducting electricity. Generally, the anode electrode may be made of a material or materials that are sufficiently conductive, such as metals, semiconductors, graphite, and conductive polymers, preferably a material or materials that is/are not prone to a loss of function over time.

For example, the anode electrode may be made from a metal material or materials able to withstand low pH values, typically boron-doped diamond.

The cathode electrode may be of any suitable size, shape and construction capable of conducting electricity. Generally, the cathode electrode may be made of a material or materials that are sufficiently conductive, such as metals, semiconductors, graphite, and conductive polymers. For example, the cathode electrode may be made from a metal material or materials such as, e.g., titanium, copper, steel or stainless steel or an alloy thereof. Typically, the cathode may be made of stainless steel.

Preferably, both the anode electrode and the cathode electrode are of a solid construction and not of a sacrificial construction.

The membrane may be of any suitable size, shape and construction capable of allowing the exchange of ions between the contents of the anode chamber and the contents of the cathode chamber.

Typically, the membrane may be a semipermeable membrane. Preferably, the membrane may be an anion exchange membrane (AEM). More preferably, the membrane may be an AEM capable of operating at extreme pH, such as, e.g. a pH of about 1.

The anode chamber and the cathode chamber may be of any suitable size, shape and construction capable of holding a volume of buffer and/or AMD. As such, the size of the anode chamber and the cathode chamber may vary depending on the volume and/or rate of AMD to be treated.

In some embodiments, the cathode chamber may typically include at least one inlet for entry of the AMD from the catholyte reservoir and at least one outlet for egress of the AMD either back to the catholyte reservoir or to a cathode chamber of a further reactor.

In some embodiments, the anode chamber may likewise typically include at least one inlet for entry of the buffer and at least one outlet for egress of the buffer either back to the anolyte reservoir or to an anode chamber of a further reactor.

In some embodiments, the apparatus may include further electrochemical reactors, such as, e.g., a third, a fourth, a fifth reactor and so on. In such embodiments, the reactor may be arranged in series for sequential selective recovery of different metals and/or elements. In some such embodiments, the predetermined pH for each reactor may be different.

Generally, the catholyte and anolyte reservoir may be of any suitable size, shape and construction for holding a volume of AMD and buffer, respectively.

For example, in some embodiments the catholyte reservoir may be formed of glass, plastic, cement or metal material or materials or a composite thereof.

Likewise, the anolyte reservoir may be of any suitable size, shape and construction capable of holding a volume of buffer and to aid in recovery of at least sulphuric acid.

In some embodiments, the catholyte reservoir may be formed of glass, cement, plastic or metal material or materials or a composite thereof able to withstand low and high pH values.

In some embodiments, the anolyte reservoir and/or catholyte reservoir may be formed of polyethylene.

In some embodiments, the catholyte reservoir and/or the anolyte reservoir may be vented to maintain atmospheric pressure. For example, the catholyte and/or anolyte reservoirs may include one or more vented openings to maintain equalization with atmospheric pressure.

In some embodiments, the catholyte reservoir may be a precipitation chamber for assisting in the recovery of the metals and the critical elements.

As indicated above, the apparatus includes at least one sensor suitable for monitoring the pH of the contents of the reactor. The sensor may include any sensor suitable for measuring a pH of the contents of the reactor. In particular, the at least one sensor may include any sensor capable of measuring the pH of the AMD.

For example, the sensor may be a pH meter, a combination pH sensor, a differential pH sensor, a laboratory pH electrode, a process pH probe, a sealed electrode, a refillable electrode, a single junction electrode, a double junction electrode, a flushable junction electrode, a class capillary electrode, a wick junction electrode, a ceramic junction electrode. Typically, the sensor may be a type that may withstand immersion in solutions of low pH over an extended period.

In some embodiments, the sensor may be a portable sensor, such as, e.g. a hand-held sensor, or may be a fixed sensor.

In some embodiments, the sensor may be permanently in contact with the AMD being treated to continuously monitor the pH. Alternatively, the sensor may be intermittently in contact with the AMD to periodically monitor the pH. Typically, the sensor may continually monitor the pH.

In some embodiments, the apparatus may include more than one sensor. For example, the apparatus may include a first sensor for monitoring the pH of the contents of the catholyte reservoir, and a second sensor for measuring the pH of the cathode chamber. In some embodiments, the pH may be monitored in both the catholyte and analyte chambers for more precise control, for example.

The power source may include any suitable type for supplying an electric current to the electrochemical reactor. Typically, the power source may be a DC power supply, such as, e.g. photovoltaic cells, a battery or an AC power supply with a rectifier.

The size and output of the power supply may typically vary depending on the volume and/or rate of AMD to be treated.

In some embodiments, the power source may be an adjustable power supply for varying electrical output. For example, the power supply may be a programmable power supply for programming the electrical output of the power supply, such as, e.g., a benchtop power supply.

In some embodiments, supplying an electrical current to the at least one electrochemical reactor may include supplying an electrical current through the anode electrode to the cathode electrode wherein the electrical current is supplied until a predetermined pH is reached for the selective recovery of metals, critical elements, sulphuric acid and/or water.

In some embodiments, supplying an electrical current to the at least one electrochemical reactor may include supplying an electrical current through the anode electrode to the cathode electrode, wherein the electrical current is maintained until a predetermined pH is reached for the selective recovery of metals, critical elements, sulphuric acid and/or water.

In some embodiments, the selective recovery of the metals, critical elements, and sulphuric acid and water may occur without the addition of chemicals to the AMD to be treated.

Generally, the predetermined pH may be dependent on the selected metals or critical elements to be recovered. Typically, the predetermined pH may have a pH corresponding to a precipitation point of a selected metal or critical elements to be recovered. For example, the predetermined pH may be a pH of about 2, about 2.5, about 3, about 3.5, about 4, about 4.5, about 5, about 5.5, about 6, about 6.5, about 7, about 7.5, about 8, about 8.5, about 9, about 9.5, about 10 or even about 10.2.

Typically, the predetermined pH for recovery of selected metals or critical elements may be a pH value of about 4, about 7, or about 10.

In some embodiments, selective recovery of metals may include precipitation of the selected metal or metals from the AMD.

In other embodiments, the selective recovery of critical elements may include the precipitation of the critical element or elements from the AMD.

In some embodiments, the apparatus may further comprise a pump for pumping the AMD and the buffer through the apparatus.

In further embodiments, the apparatus may further include a filter for filtering the AMD before it enters the catholyte reservoir.

In other embodiments, the apparatus may further include one or more dryers for drying a recovered at least one metal and/or critical element.

In some embodiments, the apparatus may further include a conveyer system for conveying recovered metals, critical elements, sulphuric acid and/or water to a transportation vehicle. The conveyer system may be of any suitable type, for example, the conveyer system may include a chute, gravity conveyor, belt conveyor, wire mesh conveyor, bucket conveyors, vertical conveyor, spiral conveyor, vibrating conveyor, pneumatic conveyors, Aero mechanical conveyors, electric track vehicle systems, belt driven live roller conveyors, screw conveyor or auger conveyor, overland conveyor, drag conveyor or any combination thereof. Typically, the conveyer system may include at least a belt conveyer.

In other embodiments, the apparatus may further include a mixer for mixing at least one of AMD, buffer, recovered water, or recovered sulphuric acid for maintaining a substantially homogenous solution. Additionally, the mixer may ensure the pH of discharged water is in a range suitable for release to the environment.

The mixer may be of any suitable type for typically mixing at least one of the recovered water and sulphuric acid. For example, in some embodiments the mixer may be a turbine mixer or an impeller mixer.

The transportation vehicle may be any vehicle suitable for transporting at least one of recovered metals, critical elements, sulphuric acid and water. The transportation vehicle may generally be a truck. For example, in some embodiments the transportation vehicle may be a dump truck, a tipper truck, a haul truck, a mining truck, tanker truck. Typically, the transportation vehicle may be a dump truck, although tanker trucks are also envisaged.

According to a third aspect of the present invention, there is provided a process for treatment of acid mine drainage and selective recovery of at least one of metals, critical elements, sulphuric acid and water, said process including:

providing at least one electrochemical reactor;

supplying the acid mine drainage to the at least one electrochemical reactor from at least one catholyte reservoir in fluid communication with the electrochemical reactor and supplying buffer to the at least one electrochemical reactor from at least one anolyte reservoir in fluid communication with the electrochemical reactor;

monitoring a pH of contents of the reactor; and

controlling an electrical current supplied to the at least one electrochemical reactor until a desired pH is reached for the selective recovery of the at least one of metals, critical elements, sulphuric acid, and water.

According to a fourth aspect of the present invention, there is provided a process for treatment of acid mine drainage and selective recovery of at least one of metals, critical elements, sulphuric acid and water, said process including:

providing a first electrochemical reactor in fluid communication with a first catholyte reservoir and at least a second electrochemical reactor in fluid communication with a second catholyte reservoir, wherein the first and second catholyte reservoirs are also in fluid communication with each other and are for containing the acid mine drainage, providing at least one anolyte reservoir for containing a buffer, the anolyte reservoir being in fluid communication with the first reactor;

supplying the acid mine drainage to the first electrochemical reactor from the first catholyte reservoir and supplying buffer to the first electrochemical reactor from an anolyte reservoir in fluid communication with the first reactor;

supplying the acid mine drainage to the second catholyte reservoir from the first catholyte reservoir;

supplying the acid mine drainage to the second electrochemical reactor from the second catholyte reservoir and supplying buffer to the second electrochemical reactor from a cathode chamber of the first reactor that is in fluid communication with a cathode chamber of the second reactor;

monitoring a pH of contents of the first reactor and the second reactor; and

controlling an electrical current supplied to the first reactor and second reactor until a desired pH is reached for each of the first reactor and second reactor for the selective recovery of the at least one of metals, critical elements, sulphuric acid, and water.

The process of the third or fourth aspects may include one or more of the features or characteristics of the apparatus as hereinbefore described.

In some embodiments, the anode chamber of the first reactor is in fluid communication with the anode chamber of the second reactor.

In other embodiments, the anolyte reservoir may be in fluid communication with the anode chamber of the first reactor.

In some embodiments, the predetermined pH of the contents of the first reactor may be different to the predetermined pH of the contents of the second reactor.

In some embodiments, the process may include providing further electrochemical reactors, such as, e.g., a third, a fourth, or a fifth reactor and so on. In such embodiments, the reactor may be arranged in series for sequential selective recovery of different metals and/or critical elements. In some such embodiments, the desired pH for each reactor may be different.

Supplying the AMD to the at least one electrochemical reactor may include pumping the AMD from the catholyte reservoir to the cathode chamber of the electrochemical reactor.

Typically, supplying the buffer to the at least one electrochemical reactor from the at least one anolyte reservoir may include providing at least one pump for pumping the buffer from the anolyte reservoir to the anode chamber of the electrochemical reactor.

In some embodiments, the process may further include recirculating the AMD from the cathode chamber back into the catholyte reservoir.

In some embodiments, the process may further include recirculating the buffer from the anode chamber back into the anolyte reservoir.

In some embodiments, the AMD within the catholyte reservoir may include both AMD and recirculated AMD that has returned to the catholyte reservoir from the cathode chamber, wherein the contents of the catholyte reservoir may be controlled at an elevated pH compared to the AMD.

In some embodiments, recovery of selected metal and/or critical element may include precipitation of the metal and/or critical element from the AMD.

In some embodiments, the majority of the recovery of selected metals and critical elements may occur within the catholyte reservoir. For example, in such embodiments precipitant formed from the AMD may be encouraged to settle within the catholyte reservoir as a solid.

In some embodiments, the process may be a batch process. Conversely, in other embodiments, the process may be a continuous process.

In some embodiments, said monitoring the pH of contents of the reactor may include using a sensor to monitor the pH.

In some embodiments, said controlling the electrical current supplied to the at least one electrochemical reactor may include applying the electrical current within a specified voltage until a desired pH is reached.

In some embodiments, said controlling the electrical current supplied to the at least one electrochemical reactor may include applying the electrical current within a specified voltage to maintain a desired pH.

Said controlling the electrical current supplied to the at least one electrochemical reactor may be manually controlled or may be automated.

For example, in some embodiments, the electrical current may be controlled by an operator monitoring pH readings of the at least one electrochemical reactor and manually isolating, or causing to be isolated, a power supply supplying the electrical current to the at least one electrochemical reactor when the desired pH is reached.

In other embodiments, the at least one pH sensor may be operatively associated with a controller for monitoring and collecting data output from the at least one pH sensor, said controller may be configured to isolate, or cause to be isolated, the power supply when the desired pH is reached.

The controller may typically include a microcomputer or a computing device, including one or more processors and a memory, for example, for: collecting data indicative of pH values output from the at least one pH sensor; processing and comparing said data to a predetermined pH value; based on said comparing, determining whether said data is substantially the same as the predetermined pH value; and responsive to said data being the same as the predetermined pH value, isolating, or causing to be isolated, the power supply supplying the electrical current to the at least one electrochemical reactor.

In some embodiments, the controller may further include a step of resupplying, or causing to be resupplied, the electrical current to the at least one electrochemical reactor when said data varies from the predetermined pH value.

In some embodiments, the catholyte reservoir may be in fluid communication with the cathode chamber of the at least one electrochemical reactor.

In some embodiments, the anolyte reservoir may be in fluid communication with the anode chamber of the at least one electrochemical reactor.

In some embodiments, the supply of the electrical current through the anode electrode to the cathode electrode may cause reduction reactions to occur within the AMD and oxidation reactions to occur within the buffer.

In some embodiments, the reduction reactions within the AMD may encourage precipitation of one or more selected metals or critical elements within the AMD. The reduction reactions within AMD may consequently also encourage the generation of sulphate anions within the catholyte, which may migrate across the membrane from the cathode chamber to the anode chamber to generate sulphuric acid within the buffer.

In some embodiments, the process may further include flushing the cathode chamber and the cathode electrode to remove built-up material or precipitation that may have formed on and adhered to the cathode electrode.

In such embodiments the flushing may include:

stopping a supply of current to the reactor; and

flushing at least one of fresh AMD or sulphuric acid solution through the cathode chamber of the reactor to dissolve said built-up material or precipitation deposited on the surface of the cathode electrode of the reactor. Said built-up material or precipitation may typically include metals or critical elements.

In some embodiments, the desired pH for the contents of a first reactor may be different to a desired pH for the contents of a second reactor.

In some embodiments, the anode chamber of one reactor may be in fluid communication with the anode chamber of another reactor.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 shows an apparatus according to an embodiment of the present invention working in batch mode for use in the treatment of acid mine drainage and selective recovery metals, critical elements, sulphuric acid and water;

FIG. 2 shows an apparatus according to an embodiment of the present invention working in continuous mode for use in treatment of acid mine drainage and selective recovery metals, critical elements, sulphuric acid and water;

FIG. 3 shows a process flow diagram according to an embodiment of the present invention;

FIG. 4 shows a system diagram of a configuration of an example electrochemical system;

FIGS. 5a and 5b are plots of experimental and modelling data from AMD processed by an electrochemical system according to an embodiment of the present invention. The plots show concentration against pH of contaminants in the liquid phase during electrochemical treatment of acid mine drainage;

FIGS. 6a and 6b are plots showing a percentage removal of metals from treated acid mine drainage respectively obtained from Texas and Mt Morgan sites;

FIGS. 7a and 7b are plots respectively showing variations in sludge composition at different pH stages for water from tailings storage facilities within Texas and Mt Morgan closed mines;

FIGS. 8a and 8b are plots showing a solids composition of rare earth element oxides at varying pH stages obtained from Texas and Mt Morgan derived acid mine drainage, respectively; and

FIG. 9 is a plot showing solids composition of REYs recovered using electrochemical (ECR) and chemical addition (CaO and NaOH).

### DETAILED DESCRIPTION

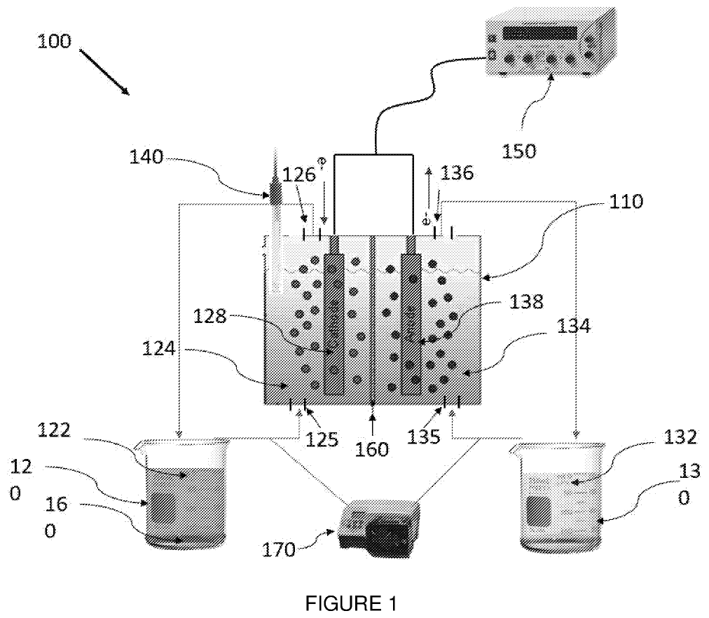

FIG. 1 shows an apparatus (100) according to an embodiment of the present disclosure for use in the treatment of acid mine drainage (122) and selective recovery metals, critical elements, sulphuric acid and water.

The apparatus (100) includes at least one electrochemical reactor (110), at least one catholyte reservoir (120) and at least one anolyte reservoir (130) for containing the acid mine drainage (122) and a 1M sodium borate buffer (132), respectively. The reservoirs (122,132) are in fluid communication with the electrochemical reactor (110), i.e., are connected by tubing (not shown).

The apparatus (100) further includes a sensor (140) for monitoring a pH of the contents of the reactor (110), and a power source (150) for supplying and controlling an electrical current to the reactor (110).

The electrical current is supplied to the reactor (110) until a predetermined pH is reached. The predetermined pH will depend on the particular metals and/or critical elements to be recovered from the AMD (122).

The apparatus further includes an AEM (160) dividing the rector (110) into a cathode chamber (124) and an anode chamber (134).

A platinum-iridium oxide coated titanium cathode electrode (128) is positioned within the cathode chamber (124) and a stainless-steel anode electrode (138) is positioned within the anode chamber (134).

The apparatus further includes a pump (170) for pumping the AMD (122) and the buffer (132) through the apparatus (100).

The cathode chamber includes an inlet (125) for entry of the AMD (122) from the catholyte reservoir (120) and an outlet (126) for egress of the AMD (122) into the catholyte reservoir (120).

Likewise, the anode chamber (134) includes an inlet (135) for entry of the buffer (132) and an outlet (136) for egress of the buffer (132) back to the anolyte reservoir (130).

In use, pump (170) is used to supply AMD (122) to the cathode chamber (124) of the reactor (110) from the catholyte reservoir (120) and to supply buffer (132) to the anode chamber (134) of the reactor (110) from the anolyte reservoir (130).

The AMD (122) is recirculated by pumping the AMD (122) within the cathode chamber (124) back into the catholyte reservoir (120).

The inlet (125) of the cathode chamber (124) accepts the AMD (122) coming from the catholyte reservoir (120). The AMD (122) coming from the catholyte reservoir (120) will be already pH adjusted and depleted of metals that precipitate at a lower pH than the prevailing pH. The AMD (122) entering the cathode chamber (124) will then have its pH raised by flowing through the cathode chamber (124). Thus, the AMD (122) flowing out of the cathode chamber (124) will have a higher pH than the AMD (122) flowing into the cathode chamber (124). The AMD (122) flowing through the outlet (126) of the cathode chamber (124) is then re-circulated into the catholyte reservoir (120) and mixed with the AMD in the catholyte reservoir (120) to control the pH in the cathode chamber (124) at a set point, which is higher than the pH of the AMD (122) flowing into the catholyte reservoir (120).

The buffer (132) is recirculated by pumping the buffer (132) within the anode chamber (134) back into the anolyte reservoir (130).

The power source (150) is used to control the supply of the electrical current to the reactor (110) by applying the electrical current with a specified voltage causing oxidation reactions to occur at the anode (138) and reduction reactions to occur at the cathode (128). The reduction reactions drive metal hydroxides, oxides or sulphates to precipitate out of the AMD (122). The pH of the AMD (122) increases due to the concentration of hydroxide ions in the AMD (122) increasing through the reduction reactions concomitantly with the migration of sulphate anions from the AMD (122) within the cathode chamber (124) through the AEM (160) into the buffer (132) contained within the anode chamber (134).

The reduction reactions within the AMD (122) encourage the generation of sulphate anions within the AMD (122), which migrate across the AEM (160) from the cathode chamber (124) to the anode chamber (134) to generate sulphuric acid within the buffer (132).

The pH of the contents of the reactor is continuously or periodically monitored using pH sensor (140) until the desired pH is reached. At the desired pH, selected metals and/or critical elements precipitate out of the AMD (122) forming precipitant (160), which is encouraged to settle within the catholyte reservoir (120).

At this point, the electrical current supplied from the power source (150) is stopped, and the precipitant (160) can then be collected from the cathode chamber (120) for further processing, if required.

Further, sulphuric acid formed within the buffer (132) from the migration of sulphate anions from the AMD (122) into the buffer (132) can be recovered.

Yet further, electrochemical removal of metals, critical elements and sulphate from the AMD (122) effectively treats the AMD to enable the recovery of treated water.

Once the pH sensor (140) reports that it has reached a desired pH for the solution, the power source (150) is isolated or stopped, and metals that become solid at that pH precipitate.

Over time metals and/or critical elements may accumulate within the cathode chamber (124) or directly adhere to the surface of the cathode electrode (128) and flushing of the cathode chamber may be required.

When flushing is required, the current supply to the reactor is stopped and either fresh AMD (122) or sulphuric acid solution is flushed through the cathode chamber (124) of the reactor (110) to dissolve any metals or critical elements deposited on the surface of the cathode electrode (128) or within the cathode chamber (124).

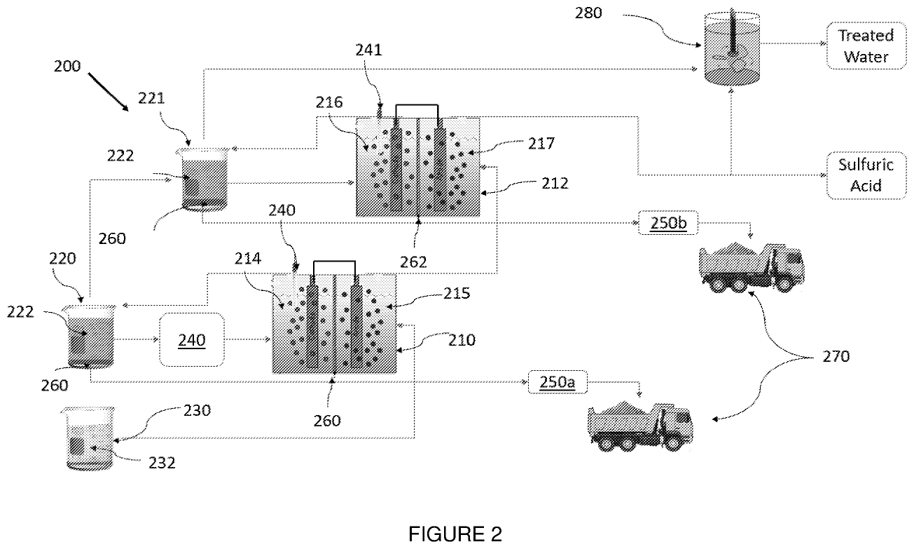

FIG. 2 shows an apparatus (200) according to another embodiment of the present disclosure for use in treatment of acid mine drainage (222) and selective recovery metals, critical elements, sulphuric acid and water.

The apparatus (200) includes a first electrochemical reactor (210) in fluid communication with a first catholyte reservoir (220) and at least a second electrochemical reactor (212) in fluid communication with a second catholyte reservoir (221), wherein the first and second catholyte reservoirs (220, 221) are in fluid communication with each other and are for containing the acid mine drainage (222).

The apparatus (200) also includes an anolyte reservoir (230) for containing a buffer (232), the anolyte reservoir (230) being in fluid communication with the first reactor (210).

The anolyte reservoir (230) is in fluid communication with the anode chamber (215) of the first reactor (210) and the anode chamber (215) of the first reactor (210) is in fluid communication with the anode chamber (217) of the second reactor (212).

The apparatus (200) also includes a first sensor (240) for monitoring the pH of the contents of the first reactor (210) and a second sensor (241) for monitoring the pH of the contents of the second reactor (212), and a power source (250, not shown) for supplying an electrical current to the first (210) and second reactors (212).

Each of the first (210) and second (212) reactors include an AEM (260, 262) dividing each reactor into a cathode chamber (214, 216) and an anode chamber (215, 217).

The anode chamber (215) of the first reactor (210) is in fluid communication with the anode chamber (217) of the second reactor (212). Further, the anolyte reservoir (230) is in fluid communication with the anode chamber (215) of the first reactor (210).

The cathode chamber (214) of the first reactor (210) includes an inlet for entry of the AMD (222) from the first catholyte reservoir (220) and an outlet for egress of the AMD (222) into the second catholyte reservoir (221).

Likewise, the anode chamber (215) of the first reactor (210) includes an inlet for entry of the buffer (232) from the anolyte reservoir (230) and an outlet for egress of the buffer (232) into the anode chamber (217) of the second reactor (212).

A pump (not shown) is used to pump the AMD (222) and the buffer (232) throughout the apparatus (200).

In the apparatus shown in FIG. 2, a filter (240) is used to filter the AMD (222) supplied from the first catholyte reservoir (220) before it enters the cathode chamber (214) of the first reactor (210).

As shown, precipitation (260) of the metals and critical elements is encouraged to settle within the first and second catholyte reservoirs (220, 221).

Dryers (250a, 250b) are included in the apparatus to dry the precipitated metals and or critical elements (260) recovered from the AMD (222) before they are conveyed to a transportation vehicle (270).

Further, a mixer (280) is included for maintaining a substantially homogenous solution of the recovered water and/or sulphuric acid-buffer solution and to ensure the pH of discharged water is suitable for environmental release, that is, having a near-neutral pH.

In use, a pump (not shown) is again used to pump AMD (222) from the first catholyte reservoir (220), through filter 240 and into the cathode chamber (214) of the first reactor (210).

The AMD (222) within the cathode chamber (214) of the first reactor (210) is then recirculated and pumped back into the first catholyte reservoir (220). Precipitant (260) formed from the AMD (222) is first encouraged to settle within the first catholyte reservoir (220).

The remaining liquid phase of the AMD (222) is then pumped from the first catholyte reservoir (220) to the second catholyte reservoir (221) before being pumped into the cathode chamber (216) of the second reactor (212).

The AMD (222) within the cathode chamber (216) of the second reactor (212) is then recirculated and pumped back into the second catholyte reservoir (221). Precipitant (260) formed from the AMD is encouraged to settle within the second catholyte reservoir (221).

The remaining liquid phase of the AMD (222) is then pumped from the second catholyte reservoir (221) into a mixer (280) before being released as clean treated water or transported for further processing.

Further, the pump (not shown) is used to supply buffer (232) to the anode chamber (215) of the first reactor (210) from the anolyte reservoir (230). The buffer (232) is then pumped into the anode chamber 217 of the second reactor (212) before being removed from the apparatus for further processing to recover sulphuric acid.

The pH of the contents of both the first (210) and second (212) reactors are continuously or periodically monitored throughout the process.

A power source (250; not shown) is used to control the supply of electrical current to the first reactor (210) and the second reactor (212) until a desired pH is met.

The predetermined pH of the contents of the first reactor (210) is different to the predetermined pH of the contents of the second reactor (212).

The predetermined pH of the AMD within the cathode chamber (214) of the first reactor (210) would typically be around 4.2 to precipitate a range of metals and the predetermined pH of the AMD within the cathode chamber (216) of the second reactor (212) would be around 10, to precipitate remaining metals and elements. At pH 4 aluminium, iron, arsenic, barium, chromium, copper, and lead are preferentially precipitated out from the AMD (222) and at pH 10 magnesium, manganese, and sulphur are preferentially precipitated out from the AMD (222). This results in the sequential selective recovery of different metals and/or critical elements. Other elements such as cadmium, cobalt, nickel, and zinc precipitate across the pH range. The pH can be controlled in smaller increments, resulting in preferential recovery of other elements at given pH values. For example, rare earths typically precipitate at a pH around 7.

Once the predetermined pH of the contents is reached for each reactor respectively, the electrical current supplied to each reactor is independently controlled so as to maintain the predetermined pH of the contents within the first and second reactors (210, 212) at their predetermined pH.

Controlling the electrical current supplied to at least one electrochemical reactor is automated in that the pH sensor is associated with a controller for monitoring and collecting data output from the pH sensor. The controller isolates the power supply when the desired pH is reached.

The controller collects data indicative of pH values output from the pH sensor and processes and compares the data to a predetermined pH value. Based on the result of the comparison the controller determines whether the data is substantially the same as the predetermined pH value or not. In response to the data being the same as the predetermined pH value, the controller isolates the power supply supplying the electrical current to the electrochemical reactor. In response to the data varying from the predetermined pH value, the controller resupplies the electrical current to the electrochemical reactor.

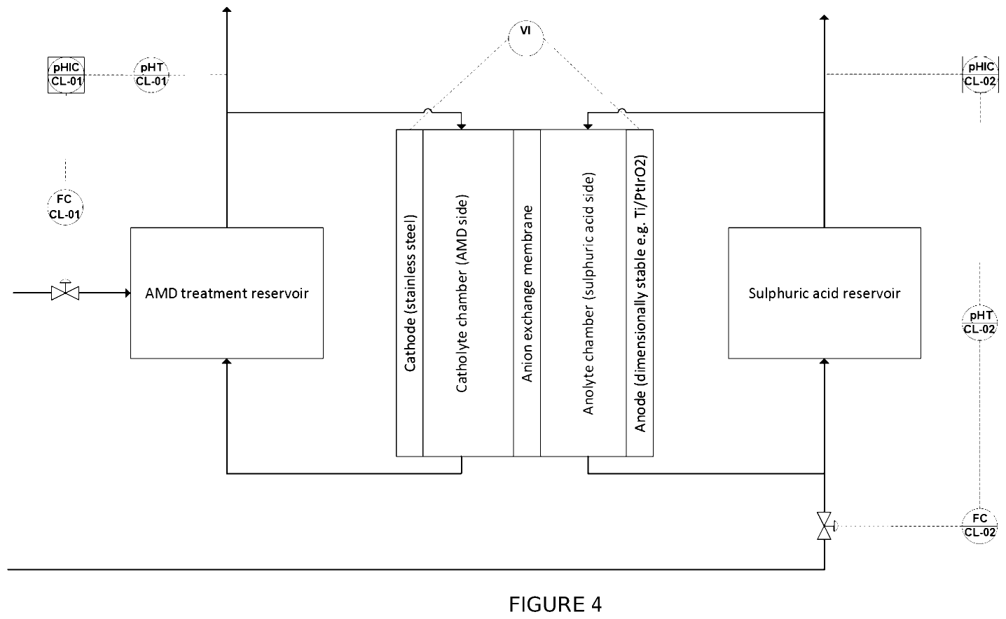

In some embodiments, the pH and flow in the chambers can be controlled automatically by pH indicator controls, transmitters, flow controls, and voltage indicators, and can remotely monitored. These controls are depicted in FIG. 4.

For the embodiment shown in FIG. 2, in the event that metals and/or critical elements accumulate within the cathode chambers (214,215) or directly adhere to the surface of the cathode electrode of the first and/or second reactors (210,212), flushing of the cathode chambers (214,215) may be required.

When flushing, the current supply to each reactor is stopped and either fresh AMD (122) or sulphuric acid solution is flushed through the cathode chamber (124) of the first reactor (110), and into the cathode chamber (214) of the second reactor (212) to dissolve any metals or critical elements deposited on the surface of the cathode electrodes or within the cathode chambers (214, 215).

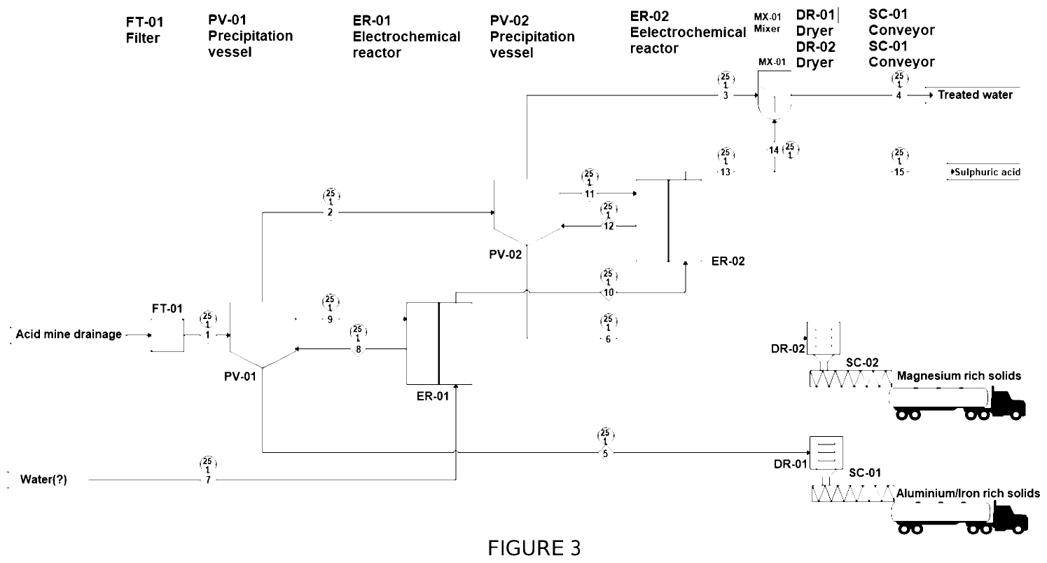

FIG. 3 shows a process flow diagram of the embodiment of the present invention as shown in FIG. 2.

### Example

The following example is provided to demonstrate how the present invention can be used to treat AMD for critical element recovery. The example shows the efficient precipitation of solid critical elements from AMD using a chemical-free approach. The example is not to be considered limiting on the scope and ambit of the present invention as hereinbefore described.

### Methods

### Modelling Methods

Both electrochemical and chemical AMD treatment relies on solubility mechanisms to precipitate the metals from the water. Through varying the charge balance of the system, by removing sulphate ions (electrochemically) or adding cations sodium and calcium (chemically) the pH of the AMD increases, which induces the precipitation of metal (oxy)hydroxides and sulphates. Solubility theory is well understood and a variety of modelling platforms are available to simulate the experiments through the evaluation of ion pairing and acid-base reactions using laws of mass-action, ionic strength using chemical activity correction factors, pH using a charge and/or mass balance, and saturation using a saturation index (SI). In the modelling here, precipitation kinetics were not considered and an equilibrium approach was assumed.

Simulations using a solubility software program, PHREEQC (Version 3), were performed to understand saturation and precipitation of high concentration metals during the different experiments. The initial solution compositions in PHREEQC were defined based on the ICP-OES analysis performed to characterize the real AMD samples. The components included: Al, Ca, Cu, Fe(II), Fe(III), Mg, Mn, Na, SO₄² and Zn. These components were included as they were in relatively high concentrations (>0.8 mM) in the samples tested and were included in the database which was used (WATEQ4F).

The equilibrium phases included in the model using the EQUILIBRIUM PHASES block were determined by running a simulation with none included to determine the possible mineral phases above saturation (considered conservatively to be a saturation index greater than 0). Then a second simulation including all the potential mineral phases previous identified was performed to evaluate which ones actually formed according to the model. Non-forming mineral phases were removed from future simulations.

For each AMD source and each method of pH amendment, a series of simulations were performed where sulphate was removed stepwise (to reflect the chemistry of the cathode solution in the electrochemical experiments) or NaOH or CaO was added stepwise (to reflect the chemical addition experiments which represent the main existing methods of treating AMD). This was done using a REACTION block. The resulting mineral phase concentrations and aqueous concentrations are the model output. The model was used to describe the processes in both the 2-stage and multistage experiments. However, there are two key limitations: a) the PHREEQC database in use (WATEQ4F) is limited to certain components and precipitation products and b) metals in low concentration (<0.8 mM) were not included.

### Experimental Methods

### Overview

Two types of experiments were performed. Both corresponded to the system configuration shown in FIG. 4. The first consisted of three treatments comparing the efficacy and sludge quality between electrochemical AMD treatment compared with chemical dosing with NaOH and slaked lime. This was performed in two pH stages. The first stage elevated the pH to 4.2 and the second to 10.2. After each stage several types settling tests were performed. The second type of experiment was multistage tests only using the electrochemical reactor (FIG. 4). The multistage tests increased the pH in smaller increments of 0.5 or 1. The smaller increments provide refined data on the nature of the precipitation relating to pH.

### Electrochemical Reactor Description

For both types of experiments the electrochemical reactor consisted of two self-manufactured chambers separated by rubber gaskets, a stainless steel cathode, a platinum-iridium oxide coated titanium electrode anode (Magneto Special Anodes B V, Netherlands), and an AEM (Membranes International IC., USA, AEM-7001) with effective area of 32 cm². The areas of the chambers were 8 cm high, 4 cm wide and 1.2 cm thick. A pump (Watson Marlow Sci 323) was used to supply 85 mL min⁻¹ flow rate (90 RPM) through the reactor with anolyte and catholyte individually recirculated to external reservoirs. The reservoirs were vented to maintain atmospheric pressure. An external power source (Elektro-Automatik GmbH & Co. KG, EA-PS 3016-10B) was used to supply an external current. The pH was measured using an Endress+Hauser Orbisint CPS11D glass electrode.

### Analytical Methods

For the liquid analysis, the composition of the AMD was analysed by inductively coupled plasma optical emission spectroscopy (ICP-OES) for major metals and inductively coupled plasma mass spectrometry (ICP-MS) for trace metals prior to use. ICP-MS samples were unfiltered and digestion was performed (USEPA SW846-3005, nitric/hydrochloric acid digestion). The process followed APHA 3125; USEPA SW846-6020 and was performed at Analytical Laboratory Services (ALS), Brisbane, Australia using their method ALS QWI-EN/EG020. Trace Hg was also analysed for using flow injection mercury system (FIMS) following AS 3550, APHA 3112 Hg-B, which was performed at Analytical Services Laboratory, Brisbane, Australia.

ICP-OES of the liquids was conducted at the Analytical Services Laboratory, The University of Queensland, Brisbane, Australia (Perkin Elmer Optima 7300DV, Waltham, Mass., USA) after nitric acid digestion for total and soluble cation concentrations.

For the dried precipitation products, ICP-OES and ICP-MS was performed at Queensland University of Technology's Central Analytical Research Facility (CARF) using a Perkin Elmer Optima 8300 DV Inductively Coupled Plasma Optical Emission Spectrometer and Agilent 8800 Inductively Coupled Plasma Mass Spectrometer, respectively.

### 2-Stage Tests

In the electrochemical treatments the catholyte was the field collected AMD (unfiltered, but let settle, stored under refrigeration until 24 h prior to experiments). The anolyte was 1 M sodium borate buffer solution. Stage 1 operated until the pH of the AMD (catholyte) reached 4.2.

Once the solution reached pH 4.2, the current was turned off. A 20 mL sample was collected for total suspended solids (TSS) analysis. The AMD then underwent a settling rate test (SRT). The SRT was performed by pouring the total AMD (catholyte) solution into a 1 L measuring cylinder. The sludge height was recorded every 3 min for the first 30 min then every 30 min for the next 2 hours and finally at 24 h. After the settling rate test, a 10 mL sample of the liquid fraction was taken for ICP-OES analysis and the liquid fraction of the solution was decanted back into a suitable bottle for the next stage of electrochemical treatment. Ten mL of the separated sludge was centrifuged (Eppendorf Centrifuge 5810) for 5 min at 3200 rcf with the sludge height measured afterwards reflecting the theoretical minimal sludge volume. The sludge volume index was determined by the volume in mL occupied by 1 g of a suspension after 30 min of settling, see Equation 1 below.

SVI (mL g⁻¹)=settled sludge volume at 30 min (mL L⁻¹)*1000/total suspended solids (TSS)(mg L⁻¹) (1)

Drying time is an important consideration in full-scale AMD treatment. To test the differences in drying time, 50 mL of each sludge was weighed, they were simultaneously dried in an oven at 60-70° C. and weighed regularly until the weight recorded a constant value. Linear regression using Microsoft Excel 2016 was performed during the 70° C. period (23.5 h until the end of drying time) to identify any differences in sludge drying time by comparing the 95% confidence intervals of the slope parameter. The dried solids from the sludge were analysed for their bulk chemical composition using ICP-OES and ICP-MS. Total suspended solids (TSS) were performed according to Standard Methods (Eaton et al., 1998).

The next stage of the electrochemical treatment was identical to the first, except the pH was now elevated to the maximum it would reach in the electrochemical reactor, around 10.2. After the pH reached −10.2, the current was again turned off and the same methods as above were repeated. When the pH stagnated in the second stage, it was assumed to be because of hydroxide ions dominating ionic migration (Thompson Brewster et al. 2017).

To compare the electrochemical treatment performance with commonly used chemical precipitation, the same experiments were performed, except rather than using electrochemical sulphate removal for pH adjustment, chemical addition with NaOH (Merck Pty Ltd, pellets for analysis, CAS-No: 1310-73-2) and with slaked lime (Alfa Aesar, reagent grade, CAS-No: 1305-78-8) were performed with the AMD contained in a beaker on a magnetic stirrer. In the same order as for the electrochemical experiments, the pH was adjusted to 4.2 then the same series of settling and sludge tests were performed. Then the solid and liquid phases separated and the liquid was raised again to pH 10.2, and the settling and sludge tests performed. The lime was prepared by mixing 1 part CaO with 9 parts water and stirring at a high rate on a magnetic stirrer for at least 10 minutes prior to use.

### Multistage Tests

The multistage tests were performed similar to the electrochemical tests, but stopped at pH 3, 3.5, 4, 4.5, 5, 6, 7, 8, 9, 10 and the final value possible (˜10.2). 1 L of Texas Silver Mine AMD was used in one experiment and 0.5 L Mt Morgan Gold Mine AMD was used in another. The anolyte was 200 mL 0.5 M sodium borate buffer solution, which was replaced if necessary when the anolyte pH fell below 7. After each pH increment was reached, the reactor was stopped, emptied and the liquid left to settle for at least 1 h in a beaker. After this, 10 mL or 4 mL samples were taken from Texas Silver Mine and Mt Morgan Gold Mine experiments, respectively. The liquid was decanted from the sludge. The liquid was used in the next stage. The remaining sludge was dried at 65° C. with the mass of sludge and solids percentage evaluated. The dried solids from the sludge were analysed for their bulk chemical composition using ICP-OES and ICP-MS. The sodium borate buffer solution was made from 61.83 g boric acid (Sigma-Aldrich, ReagentPlus®99.5%, CAS-No: 10043-35-3) and 10 g sodium hydroxide added into 1600 mL MilliQ water, stirred and made up to 2 L with MilliQ water.

### Results

### Modelling Results and Aqueous Phase Removal

### Precipitation of Solids

As follows solubility theory, different metals oxides, hydroxides and sulphates become saturated at different pHs. Modelling of the major precipitants was performed, which involved removing sulphate (as would happen in the electrochemical treatment) or adding lime or NaOH (as would happen during the chemical addition treatment). All results show that as the pH increases the initial precipitation of Al occurs firstly as jurbanite (AlOHSO₄) and then as diaspore (AlOOH). Buffering occurs at pH 4 while diaspore is forming. Once Al is completely depleted from the aqueous phase, the pH rises again until a second plateau. The second buffering stage occurs at ˜pH 10, where brucite (Mg(OH)₂) formation absorbs additional alkalinity produced through treatment. Consistent results occur between the three types of treatment indicating this is a trend common to AMD containing high concentrations of Al and Mg. The modelling and experimental results illustrate that not all metals are removed from solution evenly with increasing pH, and these differences can be used to exploit the targeted composition of the solid precipitants. It also illustrates that the trend in removal for the major metals is independent of the type of treatment—chemical or electrochemical.

Removal of Metals from the Liquid Phase

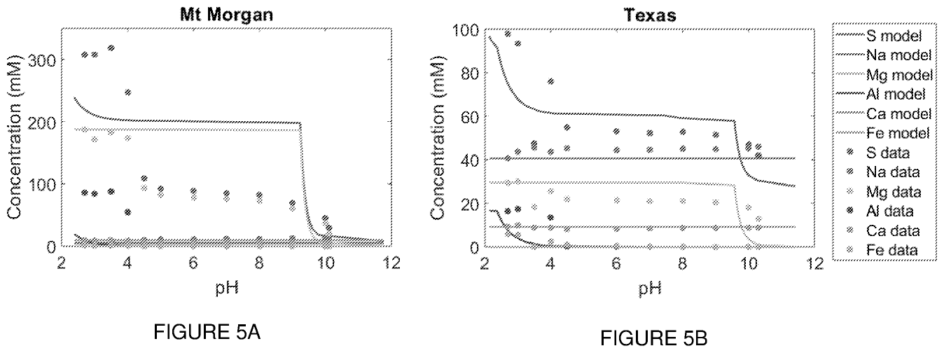

FIGS. 5a and 5b shows that the electrochemical system removes Fe, Al, Mg and SO₄, and levels of Na and Ca remain constant. Referring to FIG. 5a, the model of Mt Morgan does not validly model SO₄, Mg and Al. Epsomite (MgSO₄) was included in the PHREEQC model, but it does not reach saturation in the model. However, it is clearly forming experimentally based on the discrepancy between the experimental and model results for Mg and S. As the concentration of Mg is over 6 times higher in Mt Morgan compared to Texas (see FIG. 5b), the discrepancy is exaggerated there.

It is also possible that for both Mt Morgan and Texas, jurbanite (AlOHSO₄) is not initially saturated, as the model predicts, and that explains the slower than predicted removal of Al during the experiment at the lower pH values.

Modelling of the NaOH and lime chemical treatment was also performed across the whole pH range. In comparison to the NaOH and lime treatment, modelling illustrates that the liquid composition of AMD treated by the electrochemical cell is the least contaminated of the three methods overall. NaOH addition is not expected to reduce the sulphate concentrations, and to increase the Na concentration. However, NaOH treatment does remove Fe, Al and Mg successfully. Lime addition displays similar removal efficacy compared to ECR treatment. However, towards the high end of the pH range Ca concentrations in the liquid phase increase.

### Water Disposal Characteristics

### Water Treatment Compared to Guidelines

Tables 1 provides data for the final water quality of the AMD compared to two potential downstream uses as set out in the Australian and New Zealand Environment and Conservation Council (ANZECC) guidelines.

For both Texas and Mt Morgan AMD all three treatment options removed nearly all listed contaminants to the required guidelines, except for sulphate. The exceptions were both during lime treatment, in which there was insufficient removal of Al in Texas and Pb in Mt Morgan. For Texas, the lime treatment removed 23-26% more sulphate compared to electrochemical treatment. For Mt Morgan, ECR treatment removed the most sulphate by approximately 14-25% compared to lime. In both cases, NaOH treatment was ineffective at removing sulphate. Lime and electrochemical treatment was similar overall. However, lime treatment had two exceptions in meeting the discharge guidelines.

Some elements are potentially relevant to the ANZECC (2000) guidelines, but are not included in the table (see Table 1 footnotes). The ICP-MS results of the solid precipitate illustrates at least partial, if not full removal of arsenic, beryllium, molybdenum, selenium, uranium and vanadium was achieved. Mercury was below the detection limit of the ICP-MS in the solids and fluoride was not measured.

TABLE 1
Treated water quality, a comparison of electrochemically treated (ECR), sodium
hydroxide chemical dosing (NaOH) and lime dosing (lime).

| | | | | | | | | | ANCECC 2000 | |
|---|---|---|---|---|---|---|---|---|---|---|
| | | | | | | | | | guidelines | |
| | Texas | | | | Mt Morgan | | | | Stock | Recreational |
| Element | Original | ECR | NaOH | Lime | Original | ECR | NaOH | Lime | water* | purposes** |
| Al | 442.5 | 0.58 | 0.27 | 5.1 | 2317 | 0.55 | 0.03 | 0.74 | 5 | 0.2 |
| B | 0.69 | 0.75 | 0.62 | 0.56 | 0.00 | 2.69*** | 0.00 | 0.00 | 5 | 1 |
| Cd | 0.1 | 0.00 | 0.00 | 0.00 | 0.13 | 0.00 | 0.00 | 0.00 | 0.01 | 0.005 |
| Ca | 368.3 | 367.4 | 377.2 | 489.2 | 364.4 | 234.2 | 354.3 | 442.4 | 1000 | Not listed |
| Cr | 0.29 | 0.00 | 0.00 | 0.00 | 0.02 | 0.00 | 0.00 | 0.00 | 1 | 0.05 |
| Co | 3.0 | 0.01 | 0.05 | 0.02 | 5.16 | 0.00 | 0.01 | 0.06 | 1 | Not listed |
| Cu | 9.0 | 0.15 | 0.45 | 0.36 | 65.00 | 0.03 | 0.05 | 0.07 | 0.4 | 1 |
| Fe | 323.6 | 0.34 | 0.00 | 0.09 | 66.26 | 0.00 | 0.00 | 0.00 | Not | 0.3 |
| | | | | | | | | | sufficienly | |
| | | | | | | | | | toxic | |
| Pb | 1.3 | 0.01 | 0.06 | 0.05 | 6.18 | 0.11 | 0.07 | 0.12 | 0.1 | 0.05 |
| Mg | 714.8 | 317.2 | 245.2 | 7.35 | 4564 | 1022 | 2148 | 1188 | 2000 | Not listed |
| Mn | 63.4 | 0.93 | 0.70 | 0.12 | 244.7 | 0.84 | 0.18 | 0.18 | Not | 0.1 |
| | | | | | | | | | sufficiently | |
| | | | | | | | | | toxic | |
| Ni | 4.66 | 0.01 | 0.00 | 0.00 | 2.07 | 0.00 | 0.00 | 0.00 | 1 | 0.1 |
| Zn | 105.9 | 0.28 | 0.03 | 0.12 | 55.10 | 0.00 | 0.00 | 0.00 | 20 | 5 |
| SO4 | 9391 | 4195 | 8597 | 3099 | 29547 | 4962 | 27938 | 5769 | 1000 | 400 |

*ANZECC 2000 Table 4.3.2 also includes the elements arsenic (Texas initially over), beryllium (both within limit initially), fluoride (not measured by ICP-MS), mercury (both within limit initially), molybdenum (both within limit initially), selenium (both over limit initially), uranium (both within limit initially), and vanadium (not listed for stock water).
**ANCECC 2000 Table 5.2.3 also includes the elements arsenic (both initially over), beryllium (not listed), fluoride (not measured by ICP-MS), mercury (both within limit initially), molybdenum (not listed), selenium (both over limit initially), uranium (not listed), and vanadium (not listed).
***Boron increase due to the experimental choice of anolyte (sodium borate) and will not be present during continuous operation.

### Precipitated Solids

Removal of Metals from Solution

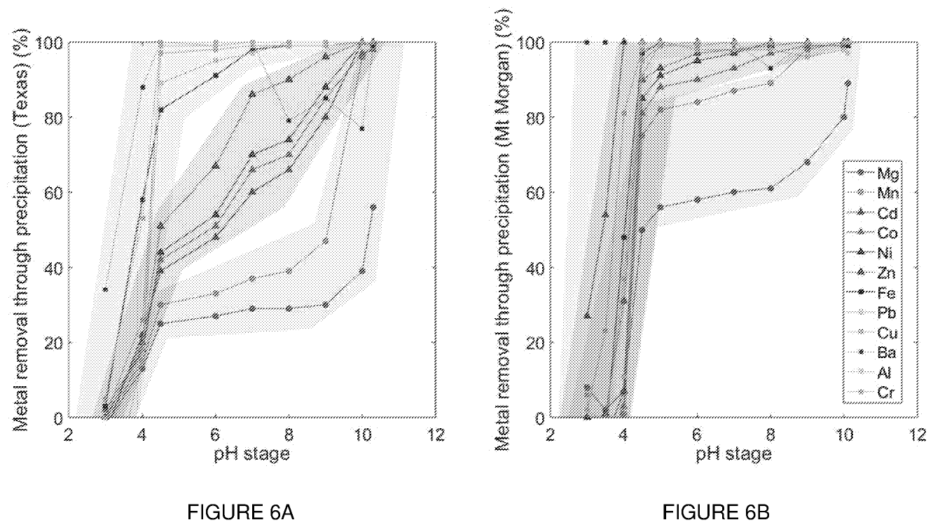

The multistage experiments illustrate that all the metals fall into three classes of removal when treated using the ECR: low pH, high pH and continuously removed. FIGS. 6a and 6b shows that Al, Ba, Cr, Cu, Fe and Pb precipitate at low pH. Mg and Mn at high pH and Cd, Co, Ni and Zn are removed continuously. The results from Texas AMD clearly show this result. However, for Mt Morgan nearly all metals are shown to precipitate at relatively low pH. This could be explained by the very high concentrations of SO₄²⁻ and Mg in Mt Morgan AMD (29 000 mg SO₄²⁻ L⁻¹, 4500 mg Mg L⁻¹) which requires a large amount of current to be added (alkalinity removed through SO₄²⁻ migration) before precipitating in amounts significant enough to increase the pH.

This order of sequential precipitation is further supported by the two stage experiments where Al, As, Ba, Cr, Cu, Fe, Mo, Se, Pb are mostly removed during the first stage; Co, Mg, Mn, Mo, Ni, Zn are largely removed during the second stage and Cd is removed in both stages relatively equally.

FIGS. 6a and 6b show the percentage removal of metals from acid mine drainage through electrochemically induced precipitation. Pollutants removed at low pH are indicated by square markers (blue), those removed at high pH by circle markers (green) and those constantly removed by triangle markers (red). The three classes of results and not clearly seen in the Mt Morgan results due to the very high concentrations of SO₄²⁻ and Mg, dominating the results (29 000 mg SO₄²⁻ L⁻¹, 4500 mg Mg L⁻¹).

### Sludge Composition

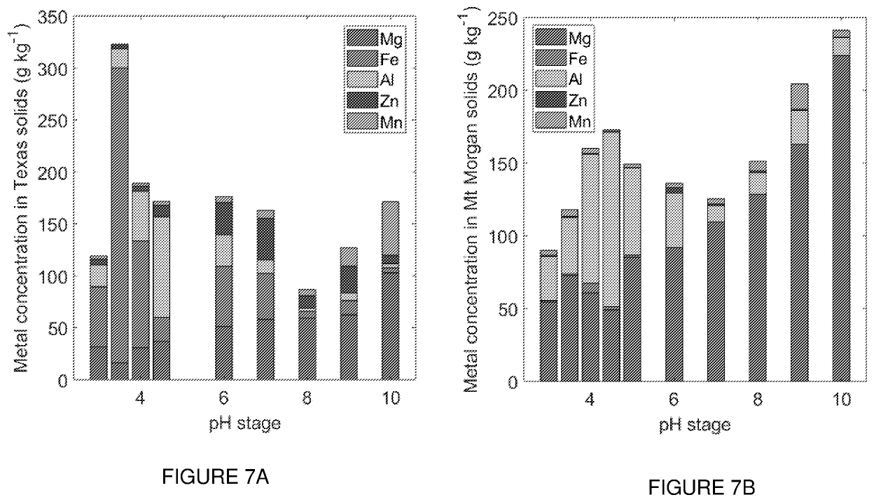

FIG. 7a and FIG. 7b shows the variation in sludge composition at the different pH stages for Texas and Mt Morgan, respectively. These graphs clearly illustrate the possibility of producing solid products with targeted composition dependent on the pH stage. Differences in staged composition are largely dependent on the initial composition of the AMD. The general trends between the results in FIGS. 7a and 7b as well as the modelling above support the selective precipitation of Fe (pH <4), Al (pH 4-6) then Mg and Mn (pH >7) as the highest concentration metals in the solid product. This data illustrates that the experimental results follow closely the solubility models and associated theory for the higher concentration metals.

### Recovery of Rare Earth Elements

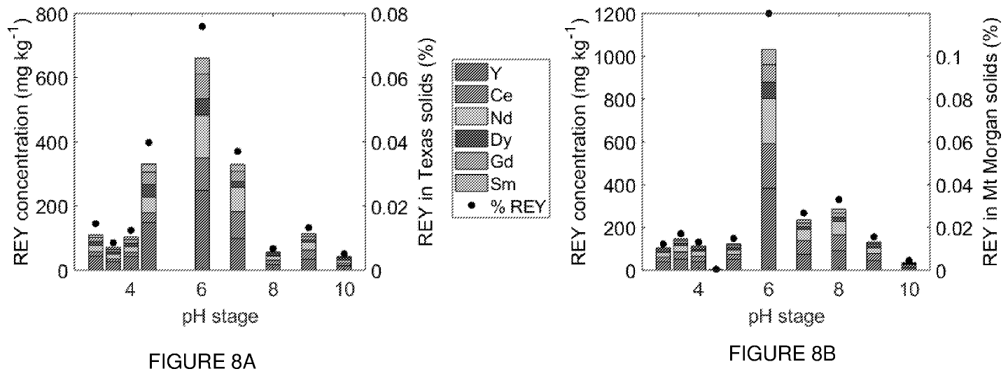

The percentage of rare earth elements and yttrium (REYs) in the solids are shown in FIGS. 8a and 8b. The highest concentration REOs are Yttrium (Y), Neodymium (Nd), Cerium (Ce), Gadolinium (Gd), Dysprosium (Dy) and Samarium (Sm). Also detected in lower concentrations were Erbium (Er), Europium (Eu), Holmium (Ho), Lutetium (Lu), Praseodymium (Pr), Terbium (Tb), Thulium (Tm) and Ytterbium (Yb). FIGS. 8a and 8b illustrate the maximum concentrations of REYs occur between a specific pH of 5-7. The prevalence of REY precipitation appears consistent between the two types of AMD.

FIGS. 8a and 8b show the solids composition of rare earth element oxides at varying pH stages. The gap between the presented REYs and the total percentage is comprised of Erbium (Er), Europium (Eu), Holmium (Ho), Lutetium (Lu), Praseodymium (Pr), Terbium (Tb), Thulium (Tm) and Ytterbium (Yb).

### Comparison to Chemical Dosing

### Major Metal Composition

In the dried solids, metals during the chemical experiments were found in lower concentrations compared to metals in the electrochemical experiments. This effect was due to the additional Ca and Na, which was precipitating during the chemical experiments, effectively ‘diluting’ the solid product. Our results support a finding that an electricity driven process can up concentrate higher levels of metals compared to chemical addition processes.

### Rare Earth Element Recovery

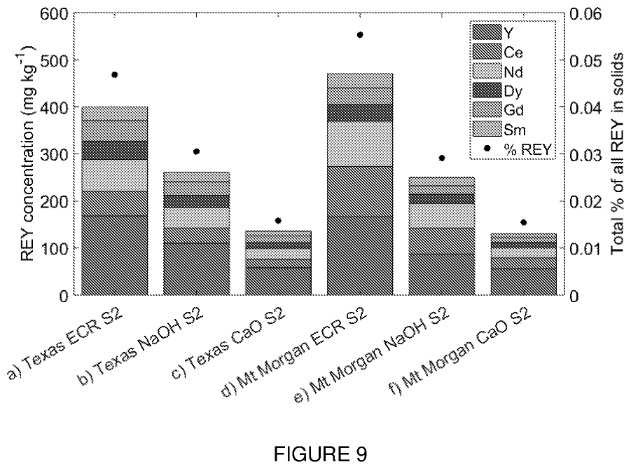

FIG. 9 compares the REY concentration in electrochemically generated solids and chemically generated solids. Stage 2 (S2, between pH 4-10) is where the majority of REYs precipitate (see FIGS. 8a and 8b). Electrochemically generated solids have higher REYs percentage composition compared to chemically generated solids. This is due to the solids from the chemical addition treatments also containing a significant mass of the elements that were added (Ca and Na), effectively ‘diluting’ the solids.

FIG. 9 shows the solids composition of REYs using electrochemical (ECR) and chemical (CaO and NaOH) addition. All values are for S2 (refers to stage 2, pH 4-10) as this was the pH range where the majority of REYs were shown to precipitate.

### Sludge Characteristics

The theoretical minimal sludge volume per litre of AMD was at least halved for electrochemically generated sludge for both samples. The electrochemically produced sludge was between 2 and 20 times smaller in volume compared to NaOH chemical addition. Centrifugation was also observed to effectively separate water from solid metal precipitates.

For all 4 permutations of the experiment the electrochemically generated sludge had the lowest SVI of those measured (measurements were not possible for Mt Morgan CaO stage 2 and Texas stage 2 NaOH due to sampling errors). There was one exception for Texas CaO stage 1, which had a particularly low SVI, corresponding to a very fast settling sludge.

For Mt Morgan, stage 1 and stage 2 electrochemically generated sludge (after settling, but before centrifugation) had the lowest percentage of solids by weight in the sludge. For Texas, NaOH had the lowest percentage of solids for both stages and CaO had the highest for both stages.

There were no significant differences in the time it took the different sludges to dry. For Mt Morgan there was only 1 sample with sufficient sludge produced for comparison. However, this dried faster than the other NaOH and lime samples for Mt Morgan. This provides some evidence that the electrochemically generated sludge may dry faster, but it requires further investigation to confirm.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

### CITATIONS

Thompson Brewster, E., Jermakka, J., Freguia, S. & Batstone, D. J. (2017) Modelling recovery of ammonium from urine by electro-concentration in a 3-chamber cell. Water Research, 124, 210-218, doi: 10.1016/j.watres.2017.07.043.
Eaton, A., Clesceri, L., Greenberg, A. & Franson, M. (1998) Standard Methods for the Examination of Water and Wastewater (20^{th} edition), American Public Health Association, Washington, D.C.

1. An apparatus for treatment of acid mine drainage, said apparatus comprising:
at least one electrochemical reactor comprising at least one anode electrode, at least one cathode electrode and a semipermeable membrane for separating the at least one anode electrode and the at least one cathode electrode and for defining an anode chamber containing the at least one anode electrode and a cathode chamber containing the at least one cathode electrode;
at least one anolyte reservoir for containing buffer and at least one catholyte reservoir for receiving and containing the acid mine drainage, said at least one anolyte reservoir and said at least one catholyte reservoir being distinct from the at least one electrochemical reactor and in fluid communication with the at least one electrochemical reactor so that said buffer can circulate between the anode chamber and the at least one anolyte chamber and said acid mine drainage can circulate between the cathode chamber and the at least one catholyte reservoir;
at least one sensor for monitoring a pH of a contents of the reactor; and
a power source for supplying an electrical current to the at least one electrochemical reactor,
wherein supply of the electrical current is controlled so that the electrical current is supplied until a predetermined pH is reached for selective recovery of at least one of metals, critical elements, sulphuric acid and water, and
wherein the selective recovery of the metals or critical elements includes precipitation of the metals or critical elements from the acid mine drainage and wherein the precipitation is encouraged to occur within the at least one catholyte reservoir to resist precipitation or adherence of precipitant on a surface of the at least one cathode electrode.

2. The apparatus of claim 1, wherein the buffer includes sodium borate buffer solution, water or an acidic buffer.

3. The apparatus of claim 1, wherein the buffer is an acidic buffer and the buffering agent is citric acid, acetic acid, hydrochloric acid or sulphuric acid.

4. The apparatus of claim 1, wherein the metals or critical elements recovered are at least one of aluminium, arsenic, barium, chromium, copper, iron, molybdenum, selenium, lead, cobalt, magnesium, manganese, molybdenum, nickel, zinc and cadmium.

5. The apparatus of claim 1, wherein the critical elements recovered include rare earth elements and yttrium (REY).

6. The apparatus of claim 1, wherein the critical elements recovered include any one or more of cerium, dysprosium, erbium, europium, gadolinium, holmium, lanthanum, lutetium, neodymium, praseodymium, terbium, thulium and ytterbium or a hydroxide, oxide, (oxy)hydroxide or sulphate thereof.

7. The apparatus of claim 5, wherein the rare earth elements recovered include any one of rhenium, rubidium, scandium, strontium, tantalum, tellurium, tin, titanium, tungsten, uranium, vanadium and zirconium.

8. The apparatus of claim 1, wherein the semipermeable membrane is an anion exchange membrane.

9. The apparatus of claim 1, wherein the sulphuric acid is recovered from the buffer within the anode chamber of the reactor.

10. The apparatus of claim 1, wherein the water is recovered from the acid mine drainage in the cathode chamber of the reactor.

11. The apparatus of claim 1, wherein the predetermined pH is dependent on the selected metals or critical elements to be recovered and wherein the predetermined pH ranges from between about 2 to about 10.2.

12. The apparatus of claim 1, further comprising one or more additional electrochemical reactors arranged in series for sequential recovery of different metals and/or critical elements.

13. (canceled)

14. (canceled)

15. A process for treatment of acid mine drainage, said process comprising:
providing at least one electrochemical reactor comprising at least one anode electrode, at least one cathode electrode and a semipermeable membrane for separating the at least one anode electrode and the at least one cathode electrode and for defining an anode chamber containing the at least one anode electrode and a cathode chamber containing the at least one cathode electrode;
providing at least one anolyte reservoir for containing buffer and at least one catholyte reservoir for receiving and containing the acid mine drainage, said at least one anolyte reservoir and said at least one catholyte reservoir being distinct from the at least one electrochemical reactor and in fluid communication with the anode chamber and the cathode chamber of the reactor, respectively;
supplying the acid mine drainage to the cathode chamber of the at least one electrochemical reactor from the at least one catholyte reservoir and supplying the buffer to the anode chamber of the at least one electrochemical reactor from the at least one anolyte reservoir;
monitoring a pH of contents of the at least one electrochemical reactor;
controlling supply of an electrical current to the at least one electrochemical reactor until a desired pH is reached for selective recovery of at least one of metals, critical elements, sulphuric acid and water; and
recirculating the acid mine drainage from the cathode chamber back into the at least one catholyte reservoir,
wherein the selective recovery of the metals or the critical elements includes precipitating the metals or the critical elements from the acid mine drainage and the pH of the catholyte reservoir is controlled at an elevated pH relative to the acid mine drainage to encourage precipitation to occur within the at least one catholyte reservoir and to resist precipitation or adherence of precipitant on a surface of the at least one cathode electrode.

16. The process of claim 15, wherein the supplying the acid mine drainage includes pumping the acid mine drainage from the at least one catholyte reservoir to the cathode chamber.

17. The process of claim 15, wherein the supplying the buffer includes pumping the buffer from the at least one anolyte reservoir to the anode chamber.

18. The process of claim 15, further comprising recirculating the buffer from the anode chamber back into the at least one anolyte reservoir.

19. The process of claim 15, wherein the process is a batch process.

20. The process of claim 15, wherein the process is a continuous process.

21. The process of claim 15, wherein the controlling the electrical current supplied to the at least one electrochemical reactor includes applying the electrical current within a specified voltage until a desired pH is reached.

22. The process of claim 15, wherein the monitoring the pH includes using at least one sensor to monitor the pH.

23. (canceled)

24. (canceled)
